(19) United States
(12) Patent Application Publication
(10) Pub. No.: US 2016/0112377 A1
(43) Pub. Date: Apr. 21, 2016

(54) METHOD OF SECURELY TRANSFERRING DATA OVER A SERVER

(71) Applicant: Jason Stover, Brattleboro, VT (US)

(72) Inventor: Jason Stover, Brattleboro, VT (US)

(21) Appl. No.: 14/517,904

(22) Filed: Oct. 19, 2014

(51) Int. Cl. H04L 29/06

(52) U.S. Cl. CPC H04L 63/0428; H04L 63/126

(57) ABSTRACT

A method of securely transferring data over a server is provided. The method may be executed by a software program on a computer. The present invention includes using an agreed upon virtual location as a password and an encryption key for the transfer of data between individuals or groups. For example, a first user may enter the virtual location on a computer. The user may then select a second user to send data to. The computer may encrypt the data using a encryption key linked to the virtual location. The data may be sent to the second user over the server. The second user may be prompted to enter a matching virtual location. Once the second user enters the matching virtual location, the data is decrypted on the second user's computer. The second user may now have access to the data.

### BACKGROUND OF THE INVENTION

The present invention relates to transferring of data and, more particularly, to a method of securely transferring data over a server.

Currently, servers contain keys that decrypt all user data transferred over the server. Therefore, a single point of failure is created and commonly exploited by hackers. Further, software programs typically require a single initial password which grants access to all of a user's data on the server. Standard passwords are typically reused by many people, meaning any compromise on one of the user's websites or applications could compromise all of the user's data. Passwords are typically very weak in order for people to remember or complex enough that they cannot be remembered and need to be written down which defeats its purpose.

As can be seen, there is a need for a secure software program for transferring data over servers.

### SUMMARY OF THE INVENTION

In one aspect of the present invention, a method of securely transferring data over a server comprises: prompting a first user to select at least a second user over the server via software executing on a computer; receiving a virtual location by the first user via software executing on a computer; receiving data from the first user via software executing on a computer; encrypting the data using a unique key comprising the virtual location via software executing on a computer; sending the encrypted data to the second user over the server via software executing on a computer; prompting the second user to enter a matching virtual location via software executing on a computer; receiving the matching virtual location from the second user via software executing on a computer, wherein the matching virtual location matches the virtual location; decrypting the data using the unique key linked via software executing on a computer; and producing the data to the second user via software executing on a computer.

In another aspect of the present invention, a method of securely transferring data over a server comprises: receiving a virtual location by a first user on the server via software executing on a computer; receiving a matching virtual location from a second user on the server via software executing on a computer, wherein the matching virtual location matches the virtual location; producing a data transfer platform for the first user and the second user on the server via software executing on a computer; receiving data from the first user via software executing on a computer; encrypting the data using a unique key linked to the virtual location via software executing on a computer; sending the encrypted data to the second user over the data transfer platform on the server via software executing on a computer; decrypting the data using the key linked to the virtual location via software executing on a computer; and producing the data to the second user via software executing on a computer.

These and other features, aspects and advantages of the present invention will become better understood with reference to the following drawings, description and claims.

### BRIEF DESCRIPTION OF THE DRAWINGS

FIG. 1 is a flow chart of the communication origination phase of the present invention;

FIG. 2 is a flow chart of the communication retrieval phase of the present invention; and

FIG. 3 is a schematic view of an exemplary communication to a group of contacts.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method of securely transferring data over a server. The method may be executed by a software program on a computer. The present invention includes using an agreed upon virtual location as a password and an encryption key for the transfer of data between individuals or groups. For example, a first user may enter the virtual location on a computer. The user may then select a second user to send data to. The computer may encrypt the data using an encryption key linked to the virtual location. The data may be sent to the second user over the server. The second user may be prompted to enter a matching virtual location. Once the second user enters the matching virtual location, the data is decrypted on the second user's computer. The second user may now have access to the data.

The present invention includes predefined virtual meeting locations used as encryption keys between a first user and a contact or group. Further, the encryption keys may be kept private from the host server. Meeting locations may be determined for each contact or group as opposed to a single password which may compromise data. Meeting locations may be different for each group because the location is agreed upon between the individuals or groups. Further, different meeting locations for different groups mean a different encryption key used for different conversations. Meeting locations are typically easier to remember than passwords and are typically much longer in length and hence increases the strength thereby preventing breaches.

The present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

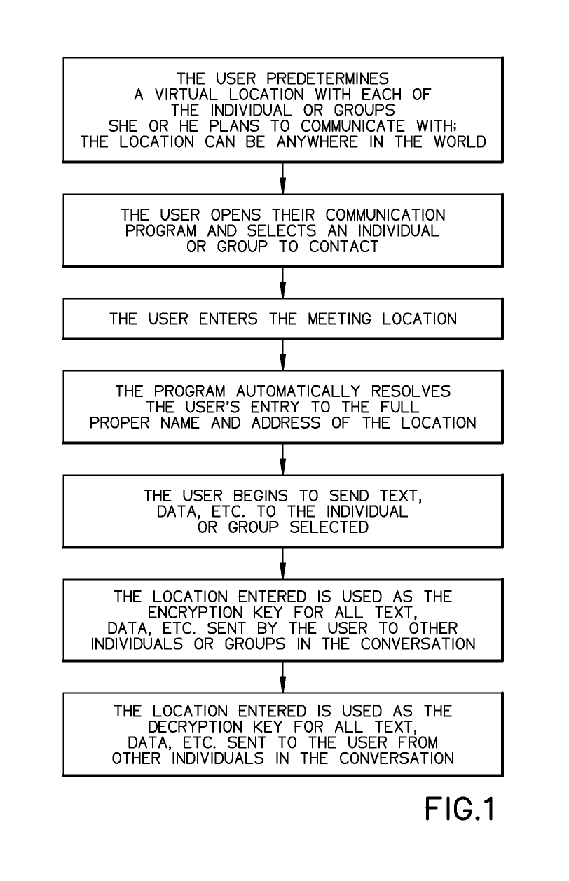

Referring to FIG. 1, the present invention may include a method of securely transferring data. At least two users, such as a group of users may predetermine a virtual location to be used as a password and an encryption/decryption key. A first user may originate the communication and data transfer with a second user or a plurality of users. The first user may open the software program and may enter the virtual location into the server. In certain embodiments, the software program may automatically resolve the user's entry and fill the proper name and address of the virtual location. The first user may then select at least a second user or a group on the server to send data to. The data may include a text message, pictures, video, audio and the like.

Once the second user or group has been selected, the first user may send the data. The data is encrypted by a unique encryption key. The unique key may be generated and linked to the virtual location that the user's had previously selected. The data may be encrypted on the first user's computer and may be send to the server to be stored. Further, if the first user receives any encrypted data from the second user or group, the data may be decrypted by the unique key. The data may then be presented to the first user.

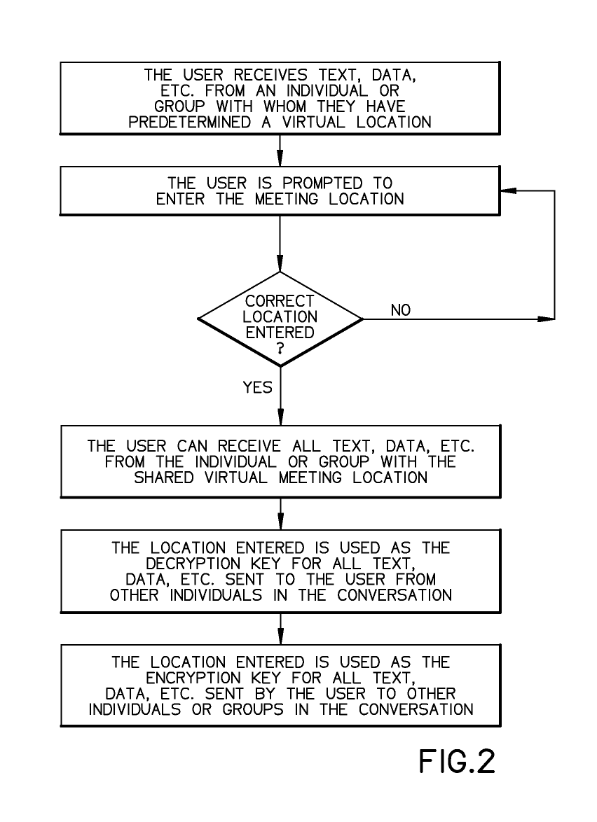

Referring to FIG. 2, the second user may receive the encrypted data from either the first user or other users from the group. In certain embodiments, the second user may accept the data, and the encrypted data may be send to the second user. The second user is then prompted to enter the virtual location agreed upon by all of the users. If the second user enters an incorrect virtual location, the second user is denied access to the data and may be prompted to enter a different virtual location. If the second user enters the correct virtual location, the second user may receive the data from the first user or group. The data may be decrypted by the unique key. The data may then be presented to the second users.

Further, if the second user sends data to the first user or the group of users, the data sent may be encrypted by the unique key.

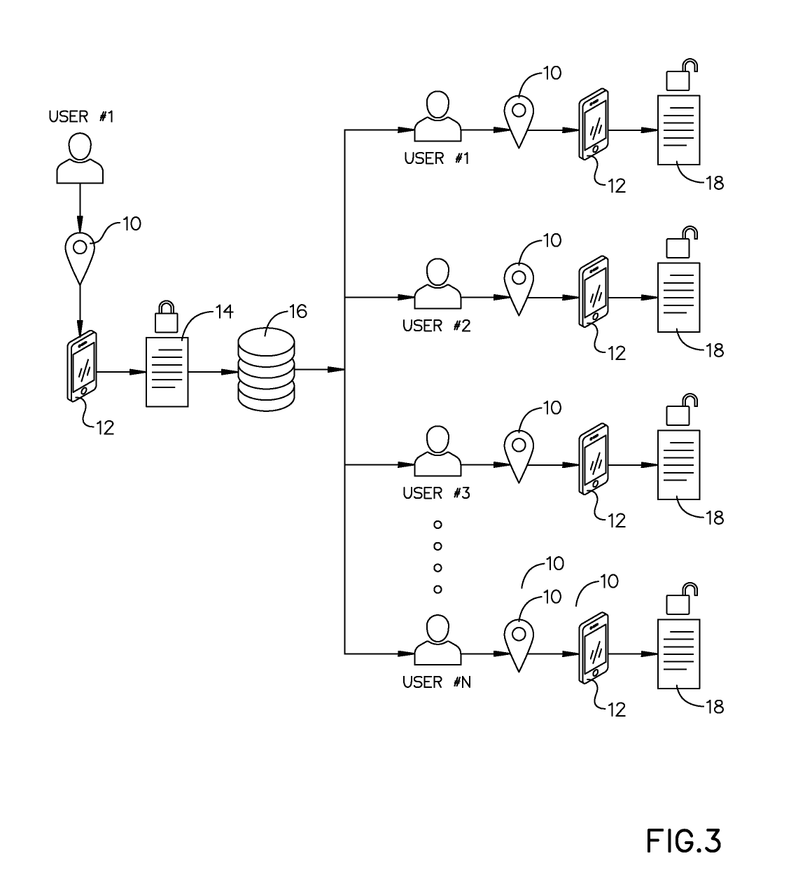

Referring to FIG. 3, a predetermined virtual location 10 may be agreed upon by the user's prior to a transfer data. A first user may enter the virtual location 10 into a computer 12, such as a smart device. The data may be encrypted into encrypted data 14 by a unique key that is linked to the virtual location 10. The data may be encrypted on the first user's computer 12. The encrypted data 14 is sent to the server 16. The server 16 may send the encrypted data 14 to at least a second user, or a plurality of users. The users may be prompted to enter the virtual location 10 into their personal computer 12. By entering the virtual location 10, the computer may decrypt the encrypted data 12, transforming the encrypted data to decrypted data 18 using the unique key. The users may then view the data presented on their computer.

The present invention may include alternate embodiments of using a virtual location to securely transfer data over a server. For example, the first user may enter the virtual location on the server using their computer. A second user may also independently enter a matching virtual location on the server using their computer. A data transfer platform may be produced for the first user and the second user. The first or second user may then send data using the data transfer platform. For example, the first user may enter data which may be encrypted on the first user's computer using a unique key linked to the virtual location. The encrypted data may be sent to the second user over the data transfer platform on the server. The second user's computer may automatically decrypt the data using the key linked to the virtual location, since the second user had already entered in the correct virtual location. The decrypted data is then presented to the second user on their computer. The above alternate embodiment may also be used with a group of users, which may enter into a group data transfer platform upon entering the virtual location. Further, user's that provide mismatching virtual locations may be denied access to the data transfer platform.

The present invention may be used for communication between individuals or groups who want more security than what's available today. The present invention starts with a virtual meeting location determined by the communicating party(s) beforehand. Each group or contact the first user communicates with may have a different virtual location. Since the location is virtual, the location may be anywhere in the world that is agreed upon. When the first user selects a person/group to communicate with, the user may be asked for that meeting location. That location may be used by those involved as an encryption key to all that is being communicated. In certain embodiments, the servers are unaware of the virtual locations and therefore the data is safe from server hacks or data handovers. The present invention allows for the security to be controlled by the communicating individuals.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of securely transferring data over a server comprising:
prompting a first user to select at least a second user over the server via software executing on a computer;
receiving a virtual location by the first user via software executing on a computer;
receiving data from the first user via software executing on a computer;
encrypting the data using a unique key comprising the virtual location via software executing on a computer;
sending the encrypted data to the second user over the server via software executing on a computer;
prompting the second user to enter a matching virtual location via software executing on a computer;
receiving the matching virtual location from the second user via software executing on a computer, wherein the matching virtual location matches the virtual location;
decrypting the data using the unique key linked via software executing on a computer; and
producing the data to the second user via software executing on a computer.

2. The method of claim 1, wherein the data is at least one of a text message, a picture, a video, and an audio.

3. The method of claim 1, wherein the at least a second user comprises a plurality of second users forming a group.

4. The method of claim 3, further comprising the step of:
receiving a mismatching virtual location from the second user via software executing on a computer; and
denying the second user access to the data via software executing on a computer.

5. The method of claim 1, further comprising the steps of:
storing the encrypted data on the server prior to sending the encrypted data to the second user;
prompting the second user to accept the encrypted data via software executing on a computer; and
sending the encrypted data to the second user via software executing on a computer, and thereafter prompting the second user to enter a matching virtual location via software executing on a computer.

6. A method of securely transferring data over a server comprising:
receiving a virtual location by a first user on the server via software executing on a computer;
receiving a matching virtual location from a second user on the server via software executing on a computer, wherein the matching virtual location matches the virtual location;
producing a data transfer platform for the first user and the second user on the server via software executing on a computer;
receiving data from the first user via software executing on a computer;
encrypting the data using a unique key linked to the virtual location via software executing on a computer;
sending the encrypted data to the second user over the data transfer platform on the server via software executing on a computer;
decrypting the data using the key linked to the virtual location via software executing on a computer; and
producing the data to the second user via software executing on a computer.

7. The method of claim 5, wherein the data is at least one of a text message, a picture, a video, and an audio.

8. The method of claim 5, further comprising the step of producing a group data transfer platform on the server for the first user prior to receiving a matching virtual location from the second user.

9. The method of claim 7, further comprising the step of receiving a matching virtual location from a plurality of users via software executing on a computer.

10. The method of claim 8, further comprising the step of granting the plurality of users access to the group data transfer platform via software executing on a computer.

11. The method of claim 5, further comprising the step of:
receiving a mismatching virtual location from a third user via software executing on a computer; and
denying the third user access to the data transfer platform via software executing on a computer.
